(19) United States
(12) Patent Application Publication
(10) Pub. No.: US 2005/0041705 A1
(43) Pub. Date: Feb. 24, 2005

(54) Automatic control device for laser power

(76) Inventors: Teng-Yuan Chien, Keelung (TW); Wei-Hsuan Chen, KaoHsiung (TW); Kevin Weng, Keelung (TW)

Correspondence Address: Raymond Sun, 12420 Woodhall Way, Tustin, CA, 92782, US

(21) Appl. No.: 10/775,520

(22) Filed: Feb. 10, 2004

(30) Foreign Application Priority Data
Aug. 22, 2003 (TW) 92215234

(51) Int. Cl. H01S 3/00

(52) U.S. Cl. 372/38.01

(57) ABSTRACT

A laser module has a laser driver that emits a green-light laser, and a reflector arranged in front of the laser driver, with the reflector receiving the emitted laser. The reflector partially passes the laser and partially reflects the laser. The laser module further includes an automatic control circuit coupled to the laser driver, the automatic control circuit having a light detector that receives the reflected laser, and based thereon, adjusts the output power of the laser driver.

### BACKGROUND OF THE INVENTION

1. Field of the Invention

The present invention relates to a laser module having an automatic control device for laser power, and in particular, to a laser module capable of maintaining a stable output of green-light laser using the feedback power of a light detector.

2. Description of the Prior Art

The laser spot or laser beam of a common laser device (such as a laser indicator, laser indexer, or laser leveler) is generally red. Although the green-light laser and the blue-light laser that have been successfully developed are more powerful and have better performance, their costs are too high. Further, one shortcoming of the green-light laser is that the power of the green-light laser tends to vary with a change in temperature. As a result, a cryostat or other radiators must be provided to lower the temperature so as to maintain a stable power output.

FIG. 1 illustrates a conventional green-light laser module 10, which has a shell 11 having a laser-emitting end 111 that emits green-light laser L1. One end of a circuit board 12 is installed inside the shell 11 and arranged with a laser room 13. The laser room 13 has a laser diode 14 that is capable of emitting infrared laser, with the laser diode 14 positioned to face a laser crystal 15 that is arranged inside a crystal sleeve 151. A lens set 16 is positioned at an end of the crystal sleeve 151 away from the laser diode 14, and includes a concave lens 161, a filter 162, and a convex lens 163, with the concave lens 161 arranged inside a lens sleeve 164, and the filter 162 secured in a seat 165 arranged in front of the lens sleeve 164. The red-light infrared laser emitted from the laser diode 14 will pass through the laser crystal 15 so as to be converted into green-light laser, which is then processed with diffusing and focusing procedures using the concave lens 161, the filter 162, and the convex lens 163 in succession, and then is finally emitted from the laser-emitting end 111 of the shell 11. A cryostat 20 is arranged at the bottom of the laser crystal 15 for maintaining an appropriate temperature, such that the power output of the green-light laser may be maintained at an optimal state. However, there are many shortcomings for the conventional laser module 10 because of the arrangement of the cryostat 20:

1. The space occupied by the cryostat 20 is too large to allow the module 10 to be miniaturized.

2. The cost is too high.

3. The cryostat consumes too much power, even more than that of a laser semiconductor, so this kind of module 10 is not suitable for use as a portable laser indexer that is normally powered by battery.

Aside from the fact that high temperature will reduce the power of the conventional green-light laser, other external factors will also influence the stability of the output power of the green-light laser, such that the laser intensity is unstable to the point where the conventional cryostat 20 cannot compensate for this instability.

### SUMMARY OF THE INVENTION

It is an object of the present invention to provide a laser module which overcomes the drawbacks described above.

It is another object of the present invention to provide a laser module having an automatic control device for maintaining a stable green-light laser output using the feedback power of a light detector.

It is yet another object of the present invention to provide a green-light laser module in which no cryostat or heat-dissipating device is needed.

It is yet a further object of the present invention to provide a green-light laser module where the cost, space, and power consumption can be minimized so that the laser module can be miniaturized.

In order to achieve the objectives of the present invention, there is provided a laser module having a laser driver that emits a green-light laser, and a reflector arranged in front of the laser driver, with the reflector receiving the emitted laser. The reflector partially passes the laser and partially reflects the laser. The laser module further includes an automatic control circuit coupled to the laser driver, the automatic control circuit having a light detector that receives the reflected laser, and based thereon, adjusts the output power of the laser driver.

In one embodiment of the present invention, the intensity of the reflected laser received by the light detector is sent as a feedback signal to the laser driver so that the laser driver can automatically adjust the output power of the laser light.

### BRIEF DESCRIPTION OF THE DRAWINGS

FIG. 1 is a cross-section view of a conventional green-light laser module.

FIG. 2 is a cross-sectional view of a modularized green-light laser module according to one embodiment of the present invention.

FIG. 3 is a perspective view of the major components of the laser module of FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

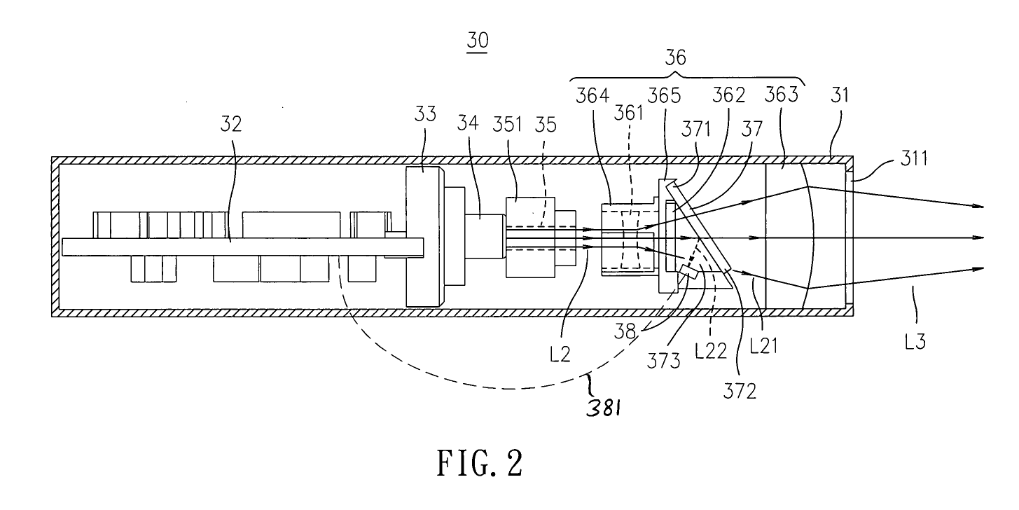

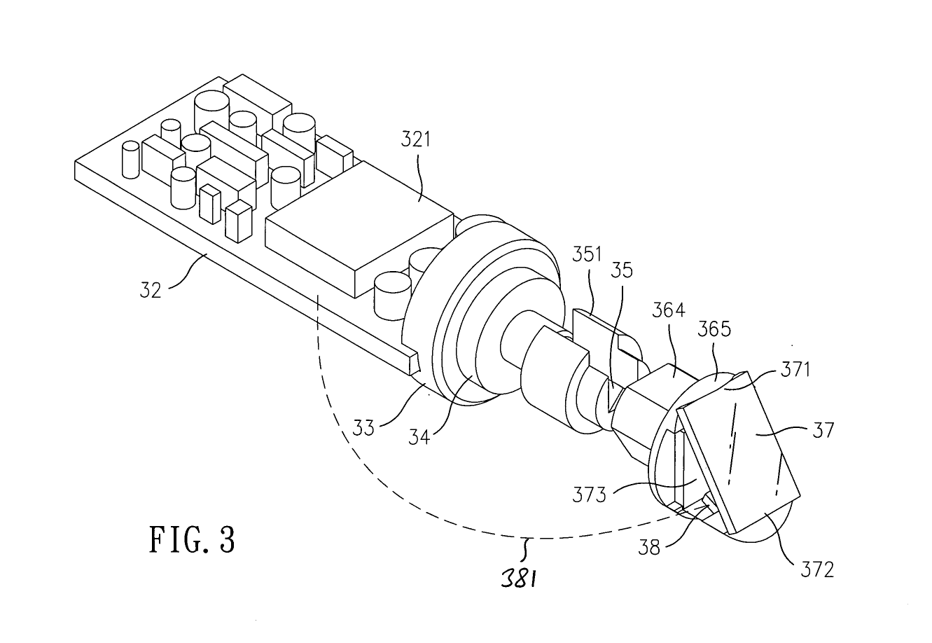

FIGS. 2-3 illustrate a green-light laser module 30 according to the present invention. The module 30 has a shell 31 which has a laser-emitting end 311 that emits a laser L21. One end of a circuit board 32 is installed inside the shell 31 and arranged with a laser room 33. The laser room 33 has a laser diode 34 that is capable of emitting infrared laser, with the laser diode 34 positioned to face a laser crystal 35 that is arranged inside a crystal sleeve 351. A lens set 36 is arranged at an end of the crystal sleeve 351 away from the laser diode 34, and includes a concave lens 361, a filter 362, and a convex lens 363. The concave lens 361 is arranged inside a lens sleeve 364, and the filter 362 is secured in an L-shaped seat 365 that is positioned in front of the lens sleeve 364.

One characteristic of the present invention is that a rectangular reflector 37 is secured in front of the seat 365. The reflector 37 is angled with respect to the filter 362 so that the upper edge 371 of the reflector 37 is abutted against the top end of the filter 362, and the bottom edge 372 of the reflector 37 is positioned furthest from the bottom end of the filter 362. Thus, the reflector 37 is angled to define a space 373 between the reflector 37 and the filter 362 for receiving a light detector 38. The light detector 38 is electrically connected to the circuit board 32 via an electric line 381.

The infrared laser emitted from the laser diode 34 passes through the laser crystal 35 and is converted into green-light laser L2, which will then sequentially pass through the concave lens 361 and the filter 362 to reach the reflector 37. When the green-light laser L2 passes through the reflector 37, depending on the materials of the reflector 37, partial green-light laser L21 will pass through the reflector 37 and form a green-light laser L3 that is emitted from the shell 31 after being focused by the convex lens 363, while another partial green-light laser L22 is reflected by the reflector 37 to form a reflecting light L22. Since the light detector 38 is arranged in the path of the reflecting light L22, the light detector 38 is capable of detecting the intensity of the reflected light L22 and provide a feedback thereof to the circuit board 32, which will adjust the output power of the laser diode 34 accordingly. The circuit board 32 includes a control circuit which receives a signal from the light detector 38 indicative of the intensity of the reflected light L22, processes this signal, and then adjusts the output power of the laser diode 34 based on the signal received from the light detector 38, using techniques that are known in the art.

The detection and feedback of the intensity of reflected light to control the output power of the laser diode 34 has made the use of a conventional cryostat unnecessary. Thus, the present invention not only minimizes labor cost, material cost, and the space otherwise needed to accomodate a cryostat, but can also detect the decrease in power. Furthermore, the present invention provides a simple arrangement for the light detector, and lowers the material cost and the power consumption of the light detector, thereby lowering the manufacturing cost.

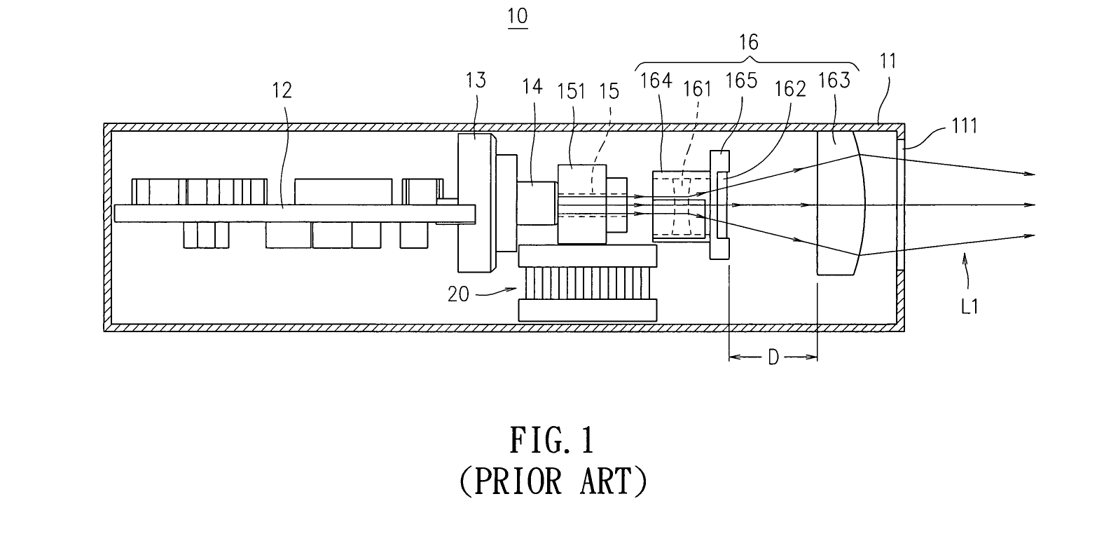

In addition to the above, the provision of the reflector 37 does not require the provision of additional space in the laser module 30. For example, as shown in FIG. 1, a specific distance D is required between the filter 162 and the concave lens 163 for the purpose of focusing. Therefore, the present invention utilizes the same distance D to positioning the reflector 37 and the light detector 38 without the need to provide additional space or to change the original structural design of the laser module. As a result, the entire structure of the laser module 30 can be miniaturized.

While the description above refers to particular embodiments of the present invention, it will be understood that many modifications may be made without departing from the spirit thereof. The accompanying claims are intended to cover such modifications as would fall within the true scope and spirit of the present invention.

1. A laser module, comprising:
a laser driver that emits a green-light laser;
a reflector arranged in front of the laser driver, the reflector receiving the emitted laser, partially passing the laser, and partially reflecting the laser; and
an automatic control circuit coupled to the laser driver, the automatic control circuit having a light detector that receives the reflected laser, and based thereon, adjusts the output power of the laser driver.

2. The laser module of claim 1, wherein the laser driver includes a circuit board, a laser diode, a laser crystal, and a lens set, wherein the laser light emitted from the laser diode sequentially passes through the laser crystal and the lens set.

3. The laser module of claim 2, wherein the lens set includes a concave lens, a filter, and a convex lens, wherein the laser enters the lens set from the concave lens and is emitted from the convex lens, and wherein the reflector is arranged between the filter and the convex lens.

4. The laser module of claim 3, wherein the reflector is angled with respect to the filter.

5. The laser module of claim 4, wherein one edge of the reflector is abutted against the filter, and another edge of the reflector is separated from the filter, such that a space is defined between the reflector and the filter for receiving the light detector.

6. The laser module of claim 1, further including a laser crystal provided in the laser driver to change the color of the laser light to green laser light.

7. A laser module, comprising:
a circuit board;
a laser diode coupled to the circuit board and emitting a laser;
a lens set;
a reflector arranged in the lens set, and which is positioned for the laser to pass through, and positioned to partially reflect the laser; and
a light detector electrically connected to the laser driver and arranged in the path of the reflected laser.

8. The laser module of claim 7, further including a laser crystal cooperating with the laser diode to change the color of the laser light to green laser light.

9. The laser module of claim 7, wherein the lens set includes a concave lens, a filter, and a convex lens, wherein the laser enters the lens set from the concave lens and is emitted from the convex lens, and wherein the reflector is arranged between the filter and the convex lens.

10. The laser module of claim 9, wherein the reflector is angled with respect to the filter.

11. The laser module of claim 10, wherein one edge of the reflector is abutted against the filter, and another edge of the reflector is separated from the filter, such that a space is defined between the reflector and the filter for receiving the light detector.
